(19) United States
(12) Patent Application Publication
(10) Pub. No.: US 2006/0271924 A1
(43) Pub. Date: Nov. 30, 2006

(54) Method and apparatus for automating updates to dependencies

(75) Inventors: Jeffrey Alan Calcaterra, Chapel Hill, NC (US); Theresa Diane Ramsey, Cary, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/140,672

(22) Filed: May 27, 2005

(51) Int. Cl. G06F 9/44

(52) U.S. Cl. 717/168

(57) ABSTRACT

Users of a software are able to, at install and runtime, confirm that the present configuration of dependency conditions including software, such as program files, data files, and hardware such as memory or hard drive capacity, will cooperate with the intended design of the software in a relatively error-free manner. This may be accomplished at those times by obtaining from a vendor site, a list of prerequisites, co-requisites, and mutually exclusive conditions to confirm proper configuration, even accounting for operating system upgrades that may have become available after the general availability of the particular software and particular version of that software

### BACKGROUND OF THE INVENTION

1. Field of the Invention

The present invention generally relates configuration management of software components located on a computer, and more particularly to a manner of obtaining up-to-date lists of files and hardware necessary and prohibited for proper software installation and execution.

2. Description of the Related Art

Installing and updating new software to a computer system is a recurring task. Such installs may allow users to fix errors, for example, via a patch, improve performance, add features, and improve security among other things.

In a business environment, where an application may be shared out to many users simultaneously, it is particularly critical that the software installs occur routinely and with as few as possible errors or impediments. In the past, high data integrity of a generally-released code would rely on the vendor to record to CD or other media all code, data, and install programs. Subsequently, delivery occurred by mail. Users or information technology staff would spend time unpacking and loading the media into the target computer system.

More recently, software can be delivered as an electronic download over the Internet. Whether the software is provided on CD or as a download over the Internet, a delay may occur between when the software is made generally-available to when the software is actually installed, run, or updated. Occasionally, information technology staff would delay making the install or upgrade, while in other cases, a new customer would receive software after several generations of code releases. In any event, disparities in staff diligence and product introduction often resulted in system configurations of processors, storage, and supporting code modules, for example, operating systems, that vary widely.

Install programs generally have fairly routine tests to verify that a target system has sufficient memory, hard-disk storage, and other hardware and software prerequisites. However, the install programs could have very involved lists of dependency conditions to properly install and run the purported features of the new code-install. Dependency conditions are also known as dependencies.

One conundrum that vendor developers face is trying to anticipate interoperability between an application and later, but not-yet-released, versions of an operating system or other dependency. The vendor can either assume that later versions of the supporting code will change enough that the current application will not be supported, or the vendor can assume that the current application version will be supported by later versions.

If the former more conservative view is expressed in the install program, many false reports may be generated by the install program that the new operating system does not support the code install or upgrade. For example, the install dependency file may state that Windows XP Service Pack 2 (SP2) is a correct and supported level and nothing more. Then, when a later service pack, SP3, becomes available after the general availability of an application, the install program will report that the required SP2 is not there and suggest an error or some caveat, such as “proceed at your own risk”.

Clearly, such messages, when incorrect, do not create a good user experience. Such messages may ultimately impact a vendor's reputation and bottom line.

In the second case, the vendor assumes that the current application version will be supported by later versions. A later version of a dependency has the possibility of causing problems with the software being installed. For example, the newer operating system level conflicts with the software. This conflict could occur during installation or while running the software. The install program may not allow the user to continue with the software installation if a particular dependency version is not present and newer levels are not deemed acceptable. This situation would prevent the user from installing the software, leading to even more marked customer dissatisfaction.

Occasionally, users may seek to free up disk space by deleting old or seldom used files. A routine deleting effort, among other things, may result in the deleting of a file or other dependency of the installed software. Thus, a possibility lingers, even at runtime of the target software, that the target software's progress may be hampered by the loss of data or code upon which the software depends.

### BRIEF SUMMARY OF THE INVENTION

The present invention provides a method, apparatus, and computer usable program code for performing software operations for an application or target software on the computer. In response to an activation of an installation program, a determination is made as to whether an updated dependency file is present at a remote source for use in performing a software operation for the target software. If the updated dependency list is present, the updated dependency file is downloaded from the remote source. A determination is made as to an absence of a failed condition using the updated dependency file. The software operation is performed for the target software in response to the absence of the failed condition.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a generic computer system in accordance with an illustrative embodiment of the present invention;

FIG. 2 is a block diagram representation in accordance with an illustrative embodiment of the present invention;

FIG. 3A is a first portion of an extended markup language file used in accordance with an illustrative embodiment of the present invention;

FIG. 3B is a second portion of an extended markup language file used in accordance with an illustrative embodiment of the present invention;

FIG. 4 is a block diagram of software and data components that may execute steps in accordance with an illustrative embodiment of the present invention;

FIG. 5 is a flowchart showing steps that may be executed to install software in accordance with an illustrative embodiment of the present invention; and

FIG. 6 is a flowchart showing steps that may be executed to install software in accordance with an illustrative embodiment of the present invention.

### DETAILED DESCRIPTION OF THE INVENTION

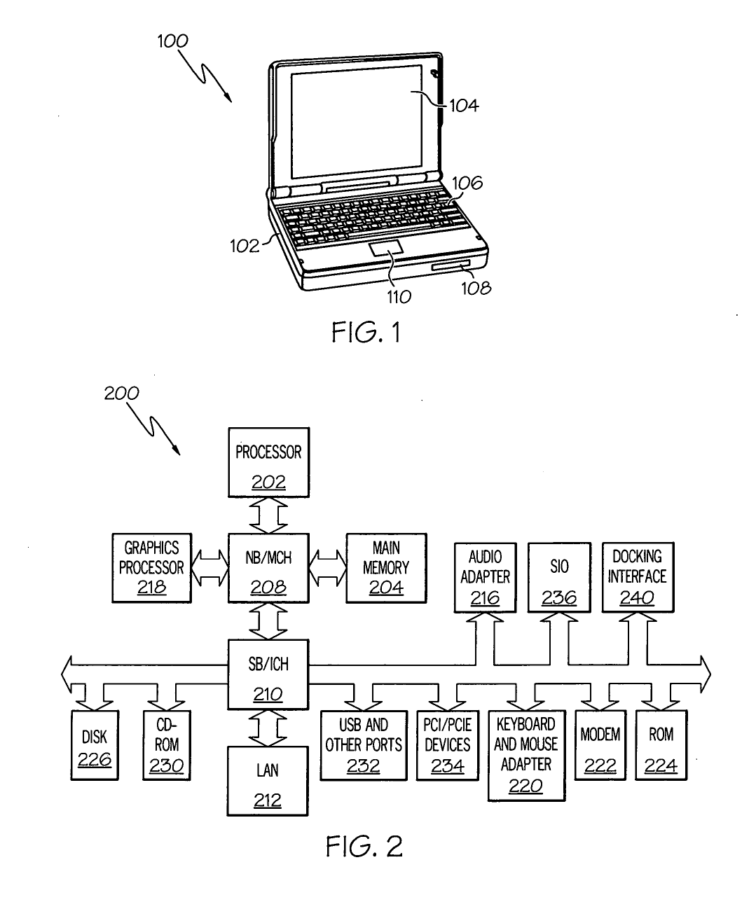

With reference now to the figures and in particular with reference to FIG. 1, a pictorial representation of a data processing system in which the present invention may be implemented is depicted in accordance with a preferred embodiment of the present invention. Computer 100 is depicted which includes system unit 102, video display terminal 104, keyboard 106, storage devices 108, which may include floppy drives and other types of permanent and removable storage media, and pointer device 110. Additional input devices may be included with computer, such as, for example, a mouse, joystick, touch screen, trackball, microphone, and the like. The computer may be implemented using any suitable computer, such as an IBM Thinkpad computer, which is a product of International Business Machines Corporation, located in Armonk, N.Y. Computer also preferably includes a graphical user interface (GUI) that may be implemented by means of systems software residing in computer readable media in operation within computer.

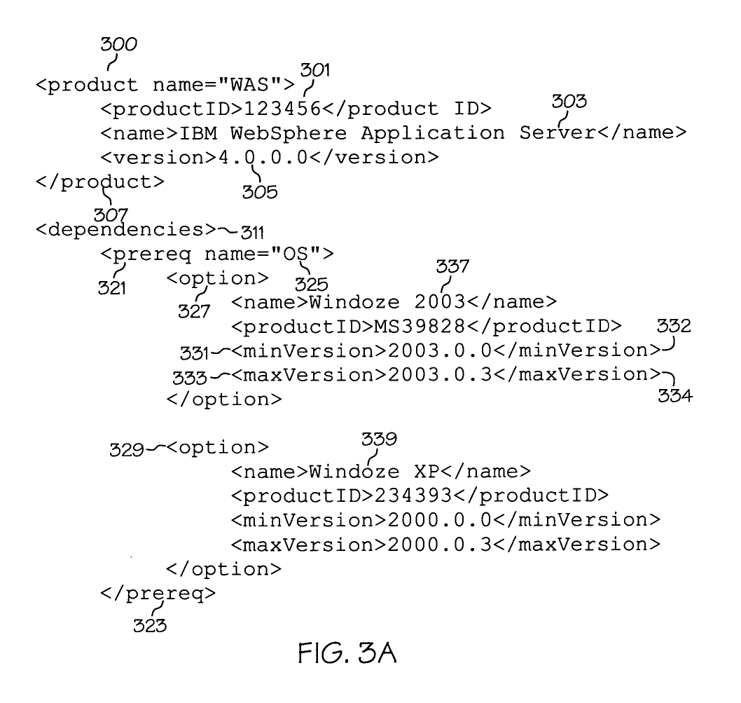

With reference now to FIG. 2, a block diagram of a data processing system is shown in which an illustrative embodiment of the present invention may be implemented. The data processing system in FIG. 2 is an example of a computer in FIG. 1, in which code or instructions implementing the processes of the present invention may be located. In the depicted example, data processing system 200 employs a hub architecture including a north bridge and memory controller hub (NB/MCH) 208 and a south bridge and input/output (I/O) controller hub (ICH) 210. Processor 202, main memory 204, and graphics processor 218 are connected to NB/MCH 208. Graphics processor 218 may be connected to the MCH through an accelerated graphics port (AGP), for example.

In the depicted example, local area network (LAN) adapter 212, audio adapter 216, keyboard and mouse adapter 220, modem 222, read only memory (ROM) 224, hard disk drive (HDD) 226, CD-ROM driver 230, universal serial bus (USB) ports and other communications ports 232, and PCI/PCIe devices 234 may be connected to SB/ICH 210. PCI/PCIe devices may include, for example, Ethernet adapters, add-in cards, PC cards for notebook computers, etc. PCI uses a cardbus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to SB/ICH 210.

Docking interface 240 may also be connected to the SB/ICH. Data processing system of FIG. 2 may be a mobile computing device, such as a laptop computer or handheld computer. Docking interface 240 provides port replication to allow the data processing system to easily connect to a keyboard, pointing device, monitor, printer, speakers, etc. The docking interface allows, for example, a mobile computing device to operate as a desktop computer with the more immobile peripheral devices.

An operating system runs on processor 202 and is used to coordinate and provide control of various components within data processing system in FIG. 2. The operating system may be a commercially available operating system such as Windows XP, which is available from Microsoft Corporation. An object-oriented programming system such as Java may run in conjunction with the operating system and provides calls to the operating system from Java programs or applications executing on data processing system. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202. The processes of the present invention are performed by processor 202 using computer implemented instructions, which may be located in a memory such as, for example, main memory 204, read only memory 224, or in one or more peripheral devices hard disk drive 226 and CD-ROM 230.

Those of ordinary skill in the art will appreciate that the hardware in FIG. 2 may vary depending on the implementation. Other internal hardware or peripheral devices, such as flash memory, equivalent nonvolatile memory, or optical disk drives and the like, may be used in addition to or in place of the hardware depicted in FIG. 2. Also, the processes of the present invention may be applied to a multiprocessor data processing system. The invention can also be extended to multi-machine software installations since some software solutions are comprised of code located on more than one computer.

For example, data processing system of FIG. 2 may be a personal digital assistant (PDA), which is configured with flash memory to provide non-volatile memory for storing operating system files and/or user-generated data. The depicted example in FIG. 2 and above-described examples are not meant to imply architectural limitations. For example, data processing system 200 also may be a tablet computer or telephone device in addition to taking the form of a PDA.

One or more illustrative embodiments of the invention may provide a mechanism by which a vendor's server may be consulted by an installer program. The installer program may be resident on the platform on which a user desires to install software. The platform may be, for example, data processing system 200 of FIG. 2. The same data processing system may execute the installer program or a separate data processing system may execute the installer program. In order to install software, several sets of dependency conditions are checked in the illustrative examples. These dependency conditions can be associated with hardware and/or software. These dependency conditions, or simply dependencies, fall into three classes in these examples, prerequisites, co-requisites, and mutually exclusive conditions. These are now defined.

A pre-requisite list may include a listed program or data file or hardware, such as hard drive space and RAM, that should be installed and available for a feature or second program to work. A pre-requisite list may also be a correspondence between a feature and a set of program files or data files that must have at least one member of the set installed and available for the feature to work.

A co-requisite list is a list of one or more programs or data files that should be installed at substantially the same time as a target program in order for the target program to work.

A mutually exclusive list is a program or data file that should not be installed. The occurrence of a mutually exclusive condition could be either software that conflicts with the to-be-installed software or an assignment of hardware, both real and virtual, that conflicts. For example, the install could attempt to use a particular port that another program already uses. But the user may want to change the port of the original program. The user may choose to continue with the install, even after the warning. Thus, the occurrence of a mutually exclusive condition may permit the user to a) override; b) uninstall; or c) stop.

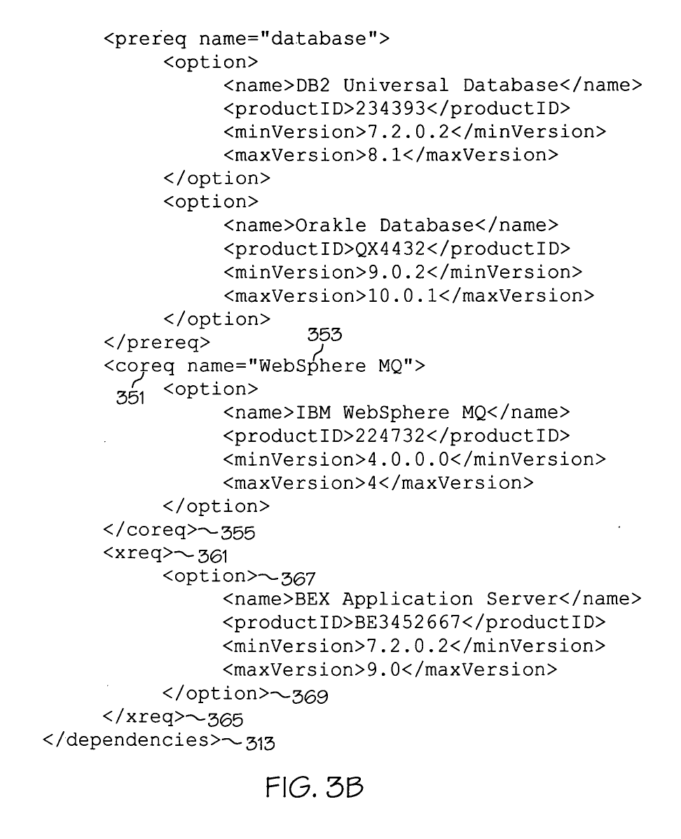

The nature of dependencies may be better understood with reference to FIGS. 3A and 3B, which show an extended markup language (XML) identifying each of the three dependency types. The dependency file may have one or more conditions that an installer program may determine are not met, and therefore, indicate a diminished performance by a target software. One or more conditions may be a prerequisite list, a co-requisite list, or a mutually exclusive list. Each dependency condition may be expressed in text bounded with extended markup language tags. For example, extended markup language tags that include the string “prereq” may bound one or more prerequisites. The string “prereq” may operate as a mnemonic for the word “prerequisite”.

An initial set of extended markup language tagged identifiers define the product or software to which the extended markup language file of dependencies applies. Extended markup language tags “productID” may bound a serial number product identifier 301. Extended markup language tag “name” may bound a title or English name string for the product 303. Extended markup language tag “version” may bound version number 305, wherein versions may be numeric, with delimiting periods to signal the significance of the version. By convention, digits to the left of a period are treated as more significant than digits to the right of a period. Similarly, comparing a short version having fewer periods to a long version having more periods, the convention is that the short version is identical to one that has a trailing sequence of “.0.0.0” subversions. For example, when comparing a short version “9.0” to a long version “7.2.0.2”, version “9.0” may be treated as equivalent to the string that occurs when appending “.0.0” or the whole string “9.0.0.0”. As is typical in extended markup language hierarchical data description, the section relating to defining the specific product to which the file applies is bounded by the “<product name=”xxxx“>” 300 tag at the beginning and the “</product>” 307 tag at the conclusion.

One or more types of dependencies may be enclosed in the pair of extended markup language tags, “<dependencies>” 311 and “</dependencies>” 313 of FIG. 3B. FIGS. 3A and 3B show the first part and second part of an exemplary dependency file, respectively. A prerequisite is enclosed in the pair of extended markup language tags, “<prereq name=”xxxx“>” 321 and “</prereq>” 323, wherein the string “xxxx” is a placeholder for the class of software or hardware that is the prerequisite. In this case, “xxxx” is “OS” 325, which may indicate an operating system dependency. This example includes options, only one of which is required to satisfy any test for, in this case, operating system dependency. Each option is bounded by the extended markup language tags, “<option>” 327 and “</option>” 329.

An expansive definition of a software or hardware may be enclosed within the option extended markup language tags, which may include a name and a product identifier, as defined earlier. In addition, a range of acceptable version numbers may be defined. The lowest acceptable version may be enclosed in the extended markup language tags “<minVersion>” 331 and “</minVersion>” 332. The highest acceptable version may be enclosed in the extended markup language tags “<maxVersion>” 333 and “</maxVersion>” 334. As may be appreciated, ranges may be defined that include low settings for memory and disk space. Low and high settings may be specified for internet protocol addresses. A lowest acceptable version, and a highest acceptable version, are examples of a range limitation. A range limitation has at least one limit specified.

The operating system prerequisites allow for either a “Windoze 2003” 337 or a “Windoze XP” 339 operating system. “Windoze XP” may be a mnemonic for “Windoze Extra Powerful”.

A corequisite section follows and is bounded by the extended markup language tags “<coreq name=”xxxx“>” 351 and “</coreq>” 355. Here the “WebSphere MQ” 353 is supplied for the “xxxx” of the tag just mentioned.

A mutually exclusive section follows and is bounded by the extended markup language tags “<xreq>” 361 and “</xreq>” 365. Recall that mutually exclusive items are forbidden if installation is desired. In the embodiments of the invention the presence of one or more mutually exclusive software or hardware causes the embodiments to stop installation of the product of software defined earlier in the file. Each dependency of the mutually exclusive section is bounded by the extended markup language tags “<option>” 367 and “</option>” 369. Each dependency has at least a name and a product identifier.

As may be appreciated, alternate embodiments may accept dependencies as several files, each file keeping a class of dependency inside itself. Various database formats may also be used as alternatives, and the embodiments of this invention are not limited to a specific form of defining the dependencies. Extended markup language is an easy-to-parse syntax for representing data. As such, the extended markup language may be well suited to distinguish the varying kinds of dependency conditions. It is appreciated that other markup language conventions may be used to identify the dependency conditions. In addition, dependency conditions may be stored in a database, or alternatively in a flat file. Thus, the embodiment of the present invention is not limited only to extended markup language representation of the dependency conditions.

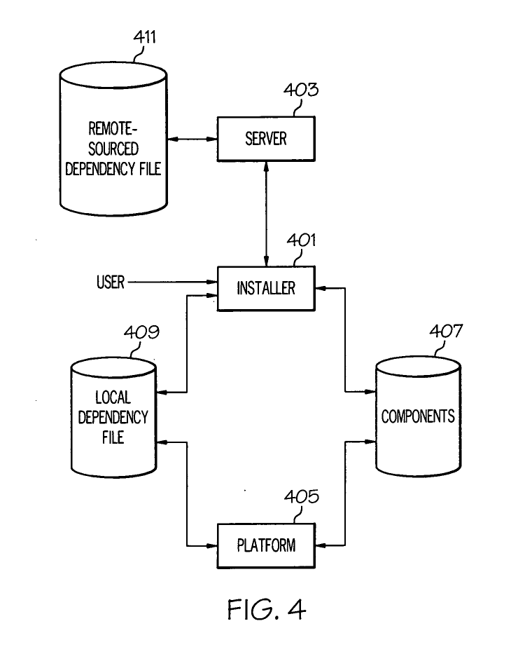

FIG. 4 shows the software components that make up the environment of an illustrative embodiment of the present invention. Installer 401 may be a program that executes on a data processing system, for example, data processing system 200 of FIG. 2. Platform 405 may be a second data processing system, or alternatively, platform 405 may be the same data processing system that executes installer. Local dependency file 409 may be on data processing system 200. Installer may have a network adapter that permits installer 401 to connect by a network to server 403. Server 403 may be a vendor owned or controlled data processing system, or simply vendor server. Stored on server 403 may be remote-sourced dependency file 411. Both local dependency file 409 and remote-sourced dependency file 411 may conform to the same standards of recording dependency conditions, extended markup language for example. Components 407 of a target software may be stored or be otherwise accessible to platform 405. Components may include data and steps in one or more files.

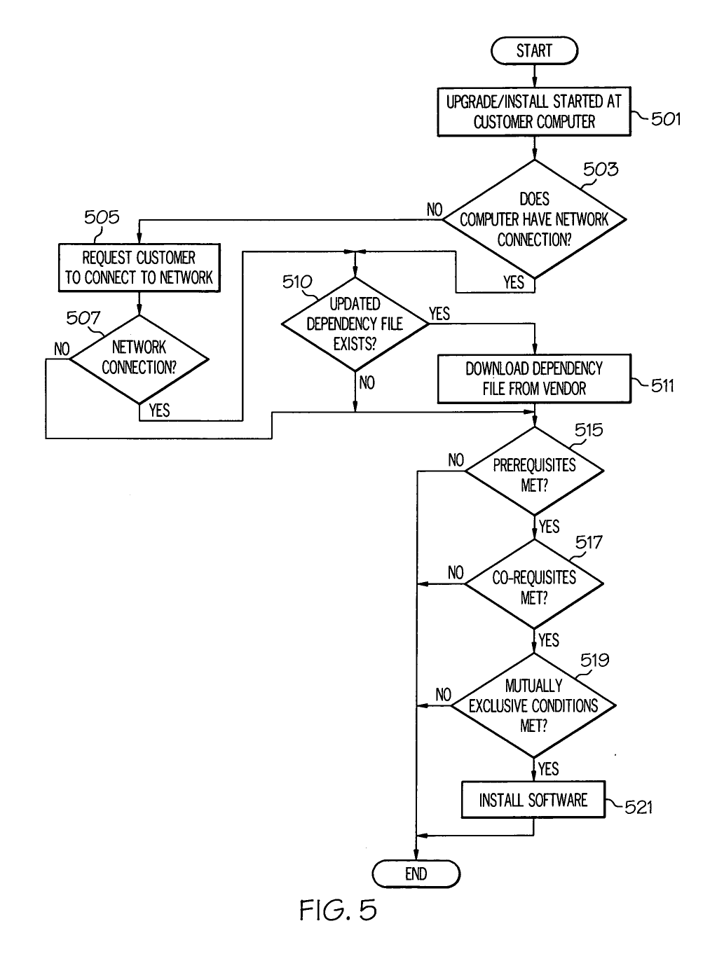

FIG. 5 shows a flowchart of a process for verifying availability of resources in accordance with an illustrative embodiment of the present invention. The process illustrated in FIG. 5 may be implemented in a data processing system, such as data processing system 200 in FIG. 2. Processing system 200 of FIG. 2 may execute the steps of an illustrative embodiment of the invention. Each of server 403, installer 401, and platform 405 may operate on distinct data processing systems. However, one or more of server 403, installer 401, and platform 405 may operate on a common data processing system as software components thereon.

The process begins with a user, perhaps at a command line prompt, commanding the installer to begin. The installer may be, for example, installer 401 of FIG. 4. The installer may receive a command or other assent from the user (step 501) selecting at least one feature of the software to be installed, but often there is a minimal feature set that is installed without need for the install program to ask the user's input. The installer may detect if there is an active network connection (step 503) by examining a network adapter for network traffic, among other things. The network adapter may be local area network adapter 212, for example, of FIG. 2.

The absence of network traffic results in the installer requesting that the user connect to the network (step 505). Such a request may be accomplished by dialog box or other methods known in the art. The installer may continuously test for network availability (step 507) or test only upon getting a positive input from the user, for example, by clicking on a “yes” dialog box button. The dependency list may also have been acquired and stored within the local computer network system, and the installer could ask the user where the newer dependency list is located. Two things, among others, may cause execution to divert, relying on the next best alternative to a remote-sourced dependency file: a fault in the interconnect to the vendor's server; or lack of an available remote-sourced dependency file. Execution diverts by using the dependency file available locally. The installer may ask the user where the newer dependency list is located. The installer may be, for example, installer 401 of FIG. 4. The local dependency file may be local dependency file 409 of FIG. 4. The vendor-server-sourced dependency file may be vendor dependency file 411. If the result of testing for computer network connection (step 503) is positive, execution continues to check for if updated file exists (step 510), explained in further detail later.

Preferably, the vendor has a file stored within a vendor's server or a site controlled by the vendor and the various network impediments do not occur. The vendor's server is also known as a remote source. Assuming that is the case, a positive result from the network connectivity test (step 507) causes further execution of checking if the remote-sourced dependency file is an updated dependency file (step 510). An updated dependency file exists when the creation or modification date associated with the remote-sourced dependency file is later than a creation or modification date associated with the local dependency file. A positive result from checking update (step 510) causes further execution of downloading the dependency file for the software (step 511). The step of downloading the dependency file may include reading the dependency file. It is appreciated that although there is shown a direct sequence of steps from first network step of attempting to download a dependency file (step 511), many things may happen during the interval from (step 503) to (step 511) that are beyond the control and scope of the invention. For example, the vendor's server could be subjected to a denial of service attack, or the vendor could have forgotten to place a dependency list file on remote source. Nevertheless, within the scope of attempting to download the dependency file is the act of actually downloading the dependency file.

In addition, the downloading of the dependency file may include downloads of several files. The collective file or files may contain one or more of a prerequisite list, a co-requisite list, and a mutually exclusive list.

Downloading may use any convenient protocol, for example, file transfer protocol, hypertext transfer protocol and the like. The format of the dependency file may be an extended markup language file or any convenient format.

Following any attempt to download an updated dependency file, the installer may check each dependency in a dependency list applicable to a selected feature or features for install, including one or more prerequisites (step 515). One point of novelty in this illustrative embodiment of the invention is that the step of checking for conditional dependencies is performed very close in time after the attempt to download the dependency file. In other words, there is a short delay between the conclusion of the downloading step (step 511) and the start of checking for conditional dependency (step 515), which may be shorter than a few seconds. The prerequisite list may show one or more conditions. Essentially, the installer checks for failed conditions. If all conditions are met, execution may continue to check the co-requisite list applicable to the selected feature or features for install (step 517). The co-requisite list may show one or more conditions. Essentially the installer checks for the absence of a failed condition. If all conditions are met, execution may continue to check the mutually exclusive list applicable to the selected feature or features for install (step 519). The mutually exclusive list may show one or more conditions. The installer checks for the absence of a failed condition. If, still, all conditions are met, the installer proceeds to perform a software operation, which may be, for example, installation of the target software (step 521). In addition, the software operation may be a removal of the target software, a maintenance operation for the target software, or an update of the target software. It is appreciated that steps 517, 519 and 521 may be performed in any order, since each of the steps involves checking a different kind of dependency.

Collectively, the steps of checking prerequisites (step 515), checking co-requisites (step 517), and checking for mutually exclusive conditions (step 519) are known as checking conditional dependencies. It is the absence of failed conditional dependencies that is the outcome of positive results from steps 515, 517 and 519.

In any event, a failure to download the vendor-server-sourced dependency file is not fatal to the continuing install and upgrade process. The default dependency file may be included among the software distribution files that comprise the software-to-be-installed, and it is that, less dynamic file, to be used for the various checks confirming available supporting programs, data, and hardware.

Optionally, the installer may ask the user to identify a preferred set of features and functions that the user desires installed as part of install command(step 501), as there may be various gradations of install that permit user preferences to be taken into account.

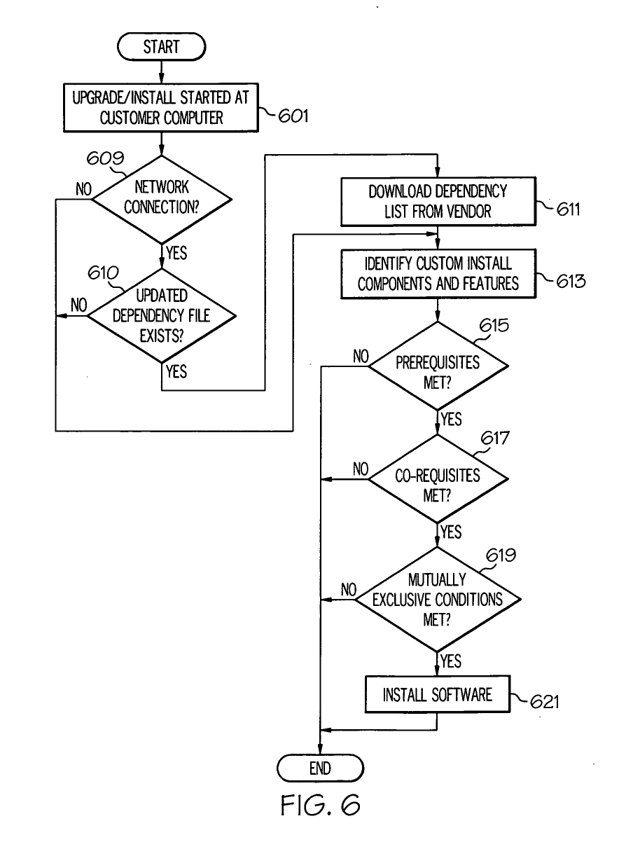

FIG. 6 shows a non-interactive embodiment of the invention. A user may initiate an upgrade or install (step 601). The installer checks for an active network connection (step 609). If one exists, the installer checks if the remote-sourced dependency file is an updated dependency file (step 610). An updated dependency file exits when the creation or modification date associated with the remote-sourced dependency file is later than a creation or modification date associated with the local dependency file. A positive result from the check (step 610) causes the installer to attempt to download a dependency file (step 611) from the vendor or from a server controlled by the vendor. However, if an active network connection is not available or other network difficulties prevent access, the embodiment may proceed to identify which components or features of the software to install (step 613). In addition, a negative result from the check (step 610) causes the installer to use the local dependency file to perform a software operation, which may include, for example, installation of the target software (step 621). Such information may be provided on the command line, as is known in the art. Thus, this step could merely be parsing the command line accordingly.

Operation continues by using the dependency file that is available from either the distribution media or the vendor's site. First, installer may confirm that the prerequisites are all met (step 615), if any. Next, installer may confirm that the co-requisites are all met (step 617), if any. Installer may next check to confirm that all mutually exclusive conditions are met (step 619), if any. Assuming that each of the conditions of the prerequisites, co-requisites, and mutually exclusive conditions are met (i.e. absence of failures), the installer may install the software (step 621). A negative outcome at any of steps 615, 617 and 619 may result in the installation being aborted, perhaps with installer issuing some warning message to the user.

Yet another embodiment could implement all the steps of FIG. 6. This embodiment is known as the “runtime embodiment” and would conform to the steps of FIG. 6 except the first step of receiving a user request to install (step 601) and the final step of installing the software (step 621). Instead, the first step could be merely a runtime invocation of the component or feature, sometimes known as “running the program”. Also, instead of installing software as the final step, this runtime embodiment could merely confirm that no adverse events have occurred that would preclude proper operation, for example, the removal of necessary software or hardware components or the addition of any mutually exclusive software components.

It is appreciated that “running the program” may be accomplished in several different ways: clicking on an icon, entering a program name on a command line or even triggering an event in a browser or other intermediate program, wherein the actual program is invoked as a plug-in.

By having an active network connection download the freshest dependency file for a proposed software install or upgrade, a user avoids many of the spurious caveat messages that occur when using an outdated dependency file that is shipped with the distribution media for the software intended for install. Fewer calls and complaints are made to the vendor, thus proactively avoiding problems. In addition, a better user experience improves the continued relationship between user and vendor.

Equally important is the fact that use of the runtime embodiment may prevent operating the software without necessary supporting software and/or hardware. The runtime embodiment makes the problem more apparent so that a remedy may be found without unknown results happening. Unknown results happen if the target software is run into a potentially more damaging error condition.

The different aspects of the present invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for performing software operations for a target software on the computer, the method comprising:
responsive to an activation of a target software, determining whether an updated dependency file is present at a remote source for use in performing a software operation for the target software;
responsive to the updated dependency file being present, downloading the updated dependency file from the remote source;
determining whether an absence of a failed condition is present using the updated dependency file; and
performing the software operation for the target software, in response to the absence of the failed condition.

2. The computer implemented method of claim 1, wherein the software operation is selected from one of an installation of the target software, removal of the target software, a maintenance operation for the target software, and an update of the target software.

3. The computer implemented method of claim 1, wherein the updated dependency file comprises at least one of a prerequisite list, a co-requisite list, and a mutually exclusive list.

4. The computer implemented method of claim 3, wherein the updated dependency file includes a range limitation.

5. The computer implemented method of claim 4 wherein the step of determining whether an absence of a failed condition is present further comprises:
checking a mutually exclusive list;
determining that a conflict exists;
displaying to a display the presence of the conflict in response to a determination that a conflict exists; and
obtaining a user input including one of override, uninstall, and stop.

6. The computer implemented method of claim 4 wherein the step of determining whether an absence of a failed condition is present further comprises:
checking a mutually exclusive list;
determining that a conflict exists;
displaying to a display the presence of the conflict in response to a determination that a conflict exists;
obtaining a user input of override, and installing the target software.

7. The computer implemented method of claim 1, wherein the dependency file is text bounded with extended markup language tags.

8. A data processing system comprising:
a bus;
a communication unit connected to the bus;
a storage device connected to the bus, wherein computer usable code is located in the storage device; and
a processing unit connected to the bus, wherein the processing unit executes the computer usable code to, responsive to an activation of a target software; determine whether an updated dependency file is present at a remote source for use in performing a software operation for the target software; download the updated dependency file from the remote source responsive to the updated dependency file being present; determine whether an absence of a failed condition is present using the updated dependency file; and perform the software operation for the target software, in response to the absence of the failed condition.

9. The data processing system of claim 8, wherein the updated dependency file comprises at least one of a prerequisite list, a co-requisite list, and a mutually exclusive list.

10. The data processing system of claim 8, wherein the updated dependency file comprises at least one of a prerequisite list, a co-requisite list, and a mutually exclusive list.

11. The data processing system of claim 10, wherein the updated dependency file includes a range limitation.

12. The data processing system of claim 10, wherein the processing unit executes the computer usable code to determine whether an absence of a failed condition is present further executes the computer usable code to check a mutually exclusive list;
determine that a conflict exists;
display to a display the presence of the conflict in response to a determination that a conflict exists; and
obtain a user input including one of override, uninstall, and stop.

13. The data processing system of claim 10, wherein the processing unit executes the computer usable code to determine whether an absence of a failed condition is present further executes the computer usable code to check a mutually exclusive list;
determine that a conflict exists;
display to a display the presence of the conflict in response to a determination that a conflict exists;
obtain a user input of override; and
install the target software.

14. The data processing system of claim 8, wherein the dependency file is text bounded with extended markup language tags.

15. A computer program product comprising:
a computer usable medium having computer usable program code for performing software operations for a target software, said computer program product including;
computer usable program code for, responsive to an activation of a target software;
determining whether an updated dependency file is present at a remote source for use in performing a software operation for the target software;
computer usable program code for, responsive to the updated dependency file being present, downloading the updated dependency file from the remote source;
computer usable program code for determining whether an absence of a failed condition is present using the updated dependency file; and
computer usable program code for performing the software operation for the target software, in response to the absence of the failed condition.

16. The computer program product of claim 15, wherein the software operation is selected from one of an installation of the target software, removal of the target software, a maintenance operation for the target software, and an update of the target software.

17. The computer program product of claim 15, wherein the updated dependency file comprises at least one of a prerequisite list, a co-requisite list, and a mutually exclusive list.

18. The computer program product of claim 17, wherein the updated dependency file includes a range limitation.

19. The computer program product of claim 18, wherein the computer usable program code for determining whether an absence of a failed condition is present further comprises:
computer usable program code for checking a mutually exclusive list;
computer usable program code for determining that a conflict exists;
computer usable program code for displaying to a display the presence of the conflict in response to a determination that a conflict exists; and
computer usable program code for obtaining a user input including one of override, uninstall, and stop.

20. The computer program product of claim 18, wherein the computer usable program code for determining whether an absence of a failed condition is present further comprises:
computer usable program code for checking a mutually exclusive list;
computer usable program code for determining that a conflict exists;
computer usable program code for displaying to a display the presence of the conflict in response to a determination that a conflict exists;
computer usable program code for obtaining a user input of override; and
computer usable program code for installing the target software.
